(19) United States
(12) Patent Application Publication
(10) Pub. No.: US 2022/0377566 A1
(43) Pub. Date: Nov. 24, 2022

(54) COMMUNICATIONS DEVICES, AND METHODS

(71) Applicant: Sony Group Corporation, Tokyo (JP)

(72) Inventors: Kazuyuki SHIMEZAWA, Basingstoke (GB); Martin Warwick BEALE, Basingstoke (GB)

(73) Assignee: Sony Group Corporation, Tokyo (JP)

(21) Appl. No.: 17/763,652

(22) PCT Filed: Oct. 9, 2020
(86) PCT No.: PCT/EP2020/078432

§ 371 Date: Mar. 25, 2022

(30) Foreign Application Priority Data
Oct. 14, 2019 (EP) 19203127.6

(51) Int. Cl. H04W 16/14; H04W 24/08

(52) U.S. Cl. CPC H04W 16/14; H04W 24/08; H04W 92/18

(57) ABSTRACT

A communications device (UE1) configured for D2D communications receives on a control channel of a D2D wireless interface an indication of communications parameters from another communications device (UE2) for that other communications device (UE2) to transmit signals representing data to the communications device (UE1) via a shared channel of the D2D wireless interface. The D2D wireless interface provides physical resources for the control channel and the physical resources of the shared channel. The communications device (UE1) receives the signals representing the data via the physical resources of the shared channel of the D2D wireless interface based on the received communications parameters. The physical resources of the shared channel of the D2D wireless interface are formed from one or both of a default bandwidth part and a non-default bandwidth part of the D2D wireless interface between the communications device (UE1) and the other communications device (UE2).

### BACKGROUND

### Field of Disclosure

The present disclosure relates to communications devices configured to communicate with other communications devices via a device-to-device (D2D) wireless access interface and methods of operating communications devices to communicate via a D2D wireless access interface.

The present disclosure claims the Paris convention priority from EP19203127.6 filed 14 Oct. 2019 the contents of which are incorporated herein by reference.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Third and fourth generation mobile telecommunication systems, such as those based on the 3GPP defined UMTS and Long Term Evolution (LTE) architecture, are able to support more sophisticated services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, may be expected to increase ever more rapidly.

One aspect of LTE is a provision for communications devices to communicate directly with each other rather than communicating via a wireless communications network. Device-to-device communications or D2D communications has been specified for LTE for devices when both in coverage and out of coverage of a wireless communications network. To communicate devices transmit and receive signals via a D2D wireless access interface.

Future wireless communications networks will be expected to routinely and efficiently support communications with a wider range of devices associated with a wider range of data traffic profiles and types than current systems are optimised to support. For example it is expected future wireless communications networks will be expected to efficiently support D2D communications, whilst utilising features of such networks. There is therefore a desire for future wireless communications networks, for example those which may be referred to as 5G or new radio (NR) system/new radio access technology (RAT) systems [1], as well as future iterations/releases of existing systems, to support D2D communications as efficiently as possible.

### SUMMARY OF THE DISCLOSURE

The present disclosure can help address or mitigate at least some of the issues discussed above.

Embodiments of the present technique can provide a method of operating a communications device configured for D2D, communications. The method comprises receiving on a control channel of a D2D wireless access interface an indication of communications parameters from another communications device for that other communications device to transmit signals representing data to the communications device via a shared channel of the D2D wireless access interface, the D2D wireless access interface providing physical resources for the control channel and the physical resources of the shared channel. The communications device may therefore be thought of as a first or receiving communications device and the other communications device may be thought of as a second or transmitting communications device. The method further comprises receiving the signals representing the data via the physical resources of the shared channel of the D2D wireless access interface based on the received communications parameters. The physical resources of the shared channel of the D2D wireless access interface are formed from a default bandwidth part and a non-default bandwidth part of the D2D wireless access interface between the communications device and the other communications device. Furthermore the default bandwidth part has a narrower bandwidth of the D2D wireless access interface than the non-default bandwidth part.

By configuring communications devices with a default bandwidth part and a non-default bandwidth part of a D2D wireless access interface, the devices can switch between communicating via the default bandwidth part and the non-default bandwidth part. Since the default bandwidth part has a lower bandwidth than the non-default bandwidth part, the communications devices can be arranged for example to reduce their power consumption when communicating data with a lower bandwidth requirement, because power consumption of the devices is proportional to a bandwidth of the D2D wireless access interface being used.

In some examples the default bandwidth part and the non-default bandwidth part may be configured by a wireless communications network, the default bandwidth part being one which is monitored and used by the communications devices, whereas the non-default bandwidth part may be used when there is a requirement for an increased bandwidth.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 schematically represents examples of communications device communicating with each other in accordance with different examples of device-to-device (D2D) communications;

FIG. 4 is a graphical representation of different bandwidth parts in frequency with respect to time illustrating a known arrangement;

FIG. 5 is a schematic block diagram illustrating communications devices in more detail communicating in accordance with device-to-device communications in accordance with example embodiments;

FIG. 6 is a graphical representation of frequency with respect to time illustrating a configuration of a device-to-device wireless access interface with a default bandwidth part and a non-default bandwidth part in accordance with one example embodiment;

FIG. 7 is a graphical representation of frequency with respect to time illustrating a configuration of a device-to-device wireless access interface with a default bandwidth part and a non-default bandwidth part in accordance with another example embodiment;

FIG. 8 is a graphical representation of frequency with respect to time illustrating a configuration of a device-to-device wireless access interface with a default bandwidth part and a non-default bandwidth part in accordance with another example embodiment; and

FIG. 9 is a flow diagram illustrating an operation of a group of communications devices according to an example embodiment.

### DETAILED DESCRIPTION OF THE EMBODIMENTS

To provide a better understanding of example embodiments the following sections provide an explanation of background techniques including an LTE network, a 5G or New Radio network and device-to-device communications.

Long Term Evolution Advanced Radio Access Technology (4G)

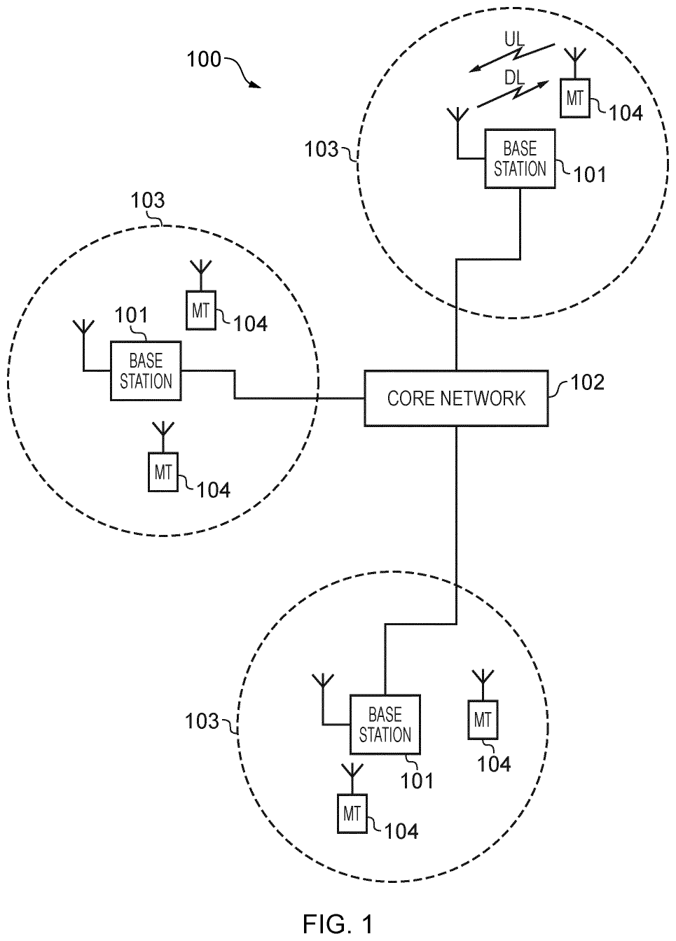

FIG. 1 provides a schematic diagram illustrating some basic functionality of a mobile telecommunications network/system 100 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP® body, and also described in many books on the subject, for example, Holma H. and Toskala A [2]. It will be appreciated that operational aspects of the telecommunications (or simply, communications) networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 100 includes a plurality of base stations 101 connected to a core network 102. Each base station provides a coverage area 103 (i.e. a cell) within which data can be communicated to and from terminal devices 104. Data is transmitted from base stations 101 to terminal devices 104 within their respective coverage areas 103 via a radio downlink (DL). Data is transmitted from terminal devices 104 to the base stations 101 via a radio uplink (UL). The core network 102 routes data to and from the terminal devices 104 via the respective base stations 101 and provides functions such as authentication, mobility management, charging and so on. Terminal devices may also be referred to as mobile stations, user equipment (UE), user terminal, mobile radio, communications device, and so forth. Base stations, which are an example of network infrastructure equipment/network access node, may also be referred to as transceiver stations/nodeBs/e-nodeBs/eNBs/g-nodeBs/gNBs and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

New Radio Access Technology (5G)

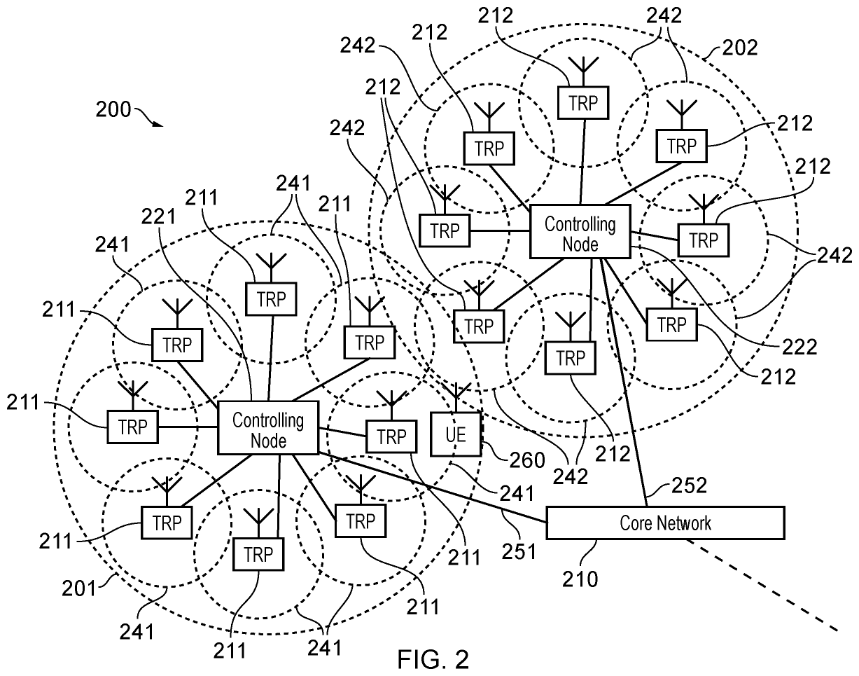

FIG. 2 is a schematic diagram illustrating a network architecture for a new RAT wireless communications network/system 200 based on previously proposed approaches which may also be adapted to provide functionality in accordance with embodiments of the disclosure described herein. The new RAT network 200 represented in FIG. 2 comprises a first communication cell 201 and a second communication cell 202. Each communication cell 201, 202, comprises a controlling node (centralised unit) 221, 222 in communication with a core network component 210 over a respective wired or wireless link 251, 252. The respective controlling nodes 221, 222 are also each in communication with a plurality of distributed units (radio access nodes/remote transmission and reception points (TRPs)) 211, 212 in their respective cells. Again, these communications may be over respective wired or wireless links. The distributed units (DUs) 211, 212 are responsible for providing the radio access interface for communications devices connected to the network. Each distributed unit 211, 212 has a coverage area (radio access footprint) 241, 242 where the sum of the coverage areas of the distributed units under the control of a controlling node together define the coverage of the respective communication cells 201, 202. Each distributed unit 211, 212 includes transceiver circuitry for transmission and reception of wireless signals and processor circuitry configured to control the respective distributed units 211, 212.

In terms of broad top-level functionality, the core network component 210 of the new RAT communications network represented in FIG. 2 may be broadly considered to correspond with the core network 102 represented in FIG. 1, and the respective controlling nodes 221, 222 and their associated distributed units/TRPs 211, 212 may be broadly considered to provide functionality corresponding to the base stations 101 of FIG. 1. The term network infrastructure equipment/access node may be used to encompass these elements and more conventional base station type elements of wireless communications systems. Depending on the application at hand the responsibility for scheduling transmissions which are scheduled on the radio interface between the respective distributed units and the communications devices may lie with the controlling node/centralised unit and/or the distributed units/TRPs.

A communications device or UE 260 is represented in FIG. 2 within the coverage area of the first communication cell 201. This communications device 260 may thus exchange signalling with the first controlling node 221 in the first communication cell via one of the distributed units 211 associated with the first communication cell 201. In some cases communications for a given communications device are routed through only one of the distributed units, but it will be appreciated in some other implementations communications associated with a given communications device may be routed through more than one distributed unit, for example in a soft handover scenario and other scenarios.

In the example of FIG. 2, two communication cells 201, 202 and one communications device 260 are shown for simplicity, but it will of course be appreciated that in practice the system may comprise a larger number of communication cells (each supported by a respective controlling node and plurality of distributed units) serving a larger number of communications devices.

It will further be appreciated that FIG. 2 represents merely one example of a proposed architecture for a new RAT communications system in which approaches in accordance with the principles described herein may be adopted, and the functionality disclosed herein may also be applied in respect of wireless communications systems having different architectures.

Thus example embodiments of the disclosure as discussed herein may be implemented in wireless telecommunication systems/networks according to various different architectures, such as the example architectures shown in FIGS. 1 and 2.

Device-to-Device Communications

Device-to-Device (D2D) communications is an aspect of mobile communications which has been established for devices to communicate directly with each other rather than via a wireless communications network. That is to say that radio signals representing data are transmitted via a wireless interface by one device and received by another to communicate that data, rather than the signals being transmitted to radio infrastructure equipment of a wireless communication network, which are then detected and decoded by the infrastructure equipment to recover that data and communicated on to a destination device.

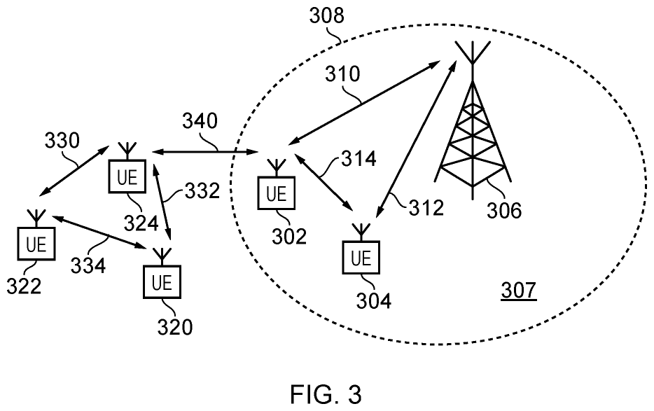

D2D communications can take different forms which are illustrated in FIG. 3. As shown in FIG. 3, in one example two communications devices (UEs) 302, 304 are operating within a coverage area of a cell 307 provided by radio infrastructure equipment 306, which has a cell boundary 308 represented by a dashed line. The radio infrastructure equipment 306 may be a TRP 211 such as that shown in FIG. 2. As represented by dashed lines 310, 312, the UEs 302, 304, may transmit and receive signals to the infrastructure equipment 306 to transmit or to receive data on an uplink or a downlink respectively of a wireless access interface formed by a wireless communications network of which the infrastructure equipment 306 forms part. However within the radio coverage area of the cell 307 the UEs 302, 304 may communicate directly between one another via a D2D wireless access interface as represented by a dashed line 314. The UEs 302, 304 can be configured to transmit and to receive signals via a D2D wireless access interface which may be separate and not shared or overlap a frequency band of the wireless access interface provided by the infrastructure equipment 306. Alternatively the UEs 302, 304 may transmit and receive signals via a part of the wireless access interface provided by the infrastructure equipment 306. A D2D wireless access interface formed for one UE to transmit radio signals to another UE is referred to as a sidelink.

Another example of D2D communications is also shown in FIG. 3 where UEs fall outside a coverage area of a wireless communication network and so communicate directly with one another. As represented by dashed lines 330, 332, 334, three UEs 320, 322, 324 transmit and receive signals representing data via sidelinks. These sidelinks 320, 322, 324 may be formed by a D2D wireless access interface which falls within a frequency band of the infrastructure equipment 306 or may be outside this frequency band. However the UEs 320, 322, 324 organise access to a D2D wireless access interface autonomously without reference to a wireless access interface. In some cases, the UEs 320, 322, 324 may be pre-configured with some parameters for a D2D wireless access interface. As another example, one of the UEs 302 within the coverage area of the cell 307 acts as a relay node for one or more of the UEs 320, 322, 324 which are outside the coverage area as represented by a sidelink 340.

Here D2D communications of the form of sidelink 314 are referred to as in-coverage communications, D2D communications of the form of sidelink 340 are referred to as partial coverage communications, and D2D communications of the form of sidelinks 330, 332, 334 are referred to as out-of-coverage communications.

According to 3GPP standards such as LTE, whilst downlink and uplink communications are specified for transmissions from an infrastructure equipment such as a gNB to a UE and from a UE to a gNB respectively, sidelink communications are specified to realise UE-to-UE (device-to-device (D2D)) communication, especially for sidelink discovery, sidelink communication and vehicle to everything (V2X) sidelink communication between UEs. The LTE sidelink has the following characteristics [3GPP specification, TS36.300, v15.7.0]:
Sidelink uses uplink resources and a physical channel structure similar to uplink transmissions. However, some changes, noted below, are made to the physical channels.
The sidelink/D2D wireless access interface structure includes a physical sidelink control channel (PSCCH) for UEs to transmit control signalling to other UEs and a physical sidelink shared channel (PSSCH) for transmitting data to other UEs. Control messages transmitted on the PSCCH can indicate communications resources of the PSSCH via which the UE will transmit data to another UE. The control message for sidelink is referred to as sidelink control information (SCI). Therefore the PSCCH is mapped to the sidelink control resources and indicates resource and other transmission parameters used by a UE for PSSCH.
Sidelink transmission uses the same basic transmission scheme as the uplink transmission scheme. However, sidelink is limited to single cluster transmissions for all the sidelink physical channels. Furthermore, sidelink uses a one symbol gap at the end of each sidelink sub-frame. For V2X sidelink communication, PSCCH and PSSCH are transmitted in the same subframe.
The sidelink physical layer processing of transport channels differs from uplink transmission in the following steps:
   Scrambling: for PSDCH and PSCCH, the scrambling is not UE-specific;
   Modulation: 256 QAM is not supported for sidelink 64 QAM is only supported for V2X sidelink communication.
For PSDCH, PSCCH and PSSCH demodulation, reference signals similar to uplink demodulation reference signals are transmitted in the fourth symbol of the slot in normal cyclic prefix (CP) and in the third symbol of the slot in extended cyclic prefix. The sidelink demodulation reference signals sequence length equals the size (number of sub-carriers) of the assigned resource. For V2X sidelink communication, reference signals are transmitted in the third and sixth symbols of the first slot and the second and fifth symbols of the second slot in normal CP.
For PSDCH and PSCCH, reference signals are created based on a fixed base sequence, cyclic shift and orthogonal cover code. For V2X sidelink communication, the cyclic shift for PSCCH is randomly selected in each transmission.
For in-coverage operation, the power spectral density of the sidelink transmissions can be influenced by the eNB.
For measurement on the sidelink, the following basic UE measurement quantities are supported:
   Sidelink reference signal received power (S-RSRP).
   Sidelink discovery reference signal received power (SD-RSRP).
   PSSCH reference signal received power (PSSCH-RSRP).
   Sidelink reference signal strength indicator (S-RSSI).

Currently, for 5G or New Radio (NR) standardisation, a sidelink has been specified in Release-16 for V2X communication, with the LTE sidelink being a starting point for the NR sidelink NR sidelink can be enhanced with a power saving mechanism for sidelink which would be a useful feature especially for D2D (device-to-device) communications between devices having limited battery power.

Bandwidth Parts and Power Consumption

UE battery life is an aspect which will influence the adoption of 5G devices and/or services. UE power saving is aimed at providing UE power efficiency for 5G NR, so that the power saving is comparable with or better than that of LTE. Release-15 UE power saving schemes can provide UE power saving in NR operation.

One of the UE power saving schemes is BWP (bandwidth part) adaptation. A BWP is a part of a carrier bandwidth providing a number of contiguous resource blocks (RBs) which can be grouped to form a bandwidth part (BWP) in NR. Multiple BWPs can exist within a carrier bandwidth, where in Release-15 up to four BWPs can be configured per UE semi-statically. However only one BWP is activated per UE at a given time.

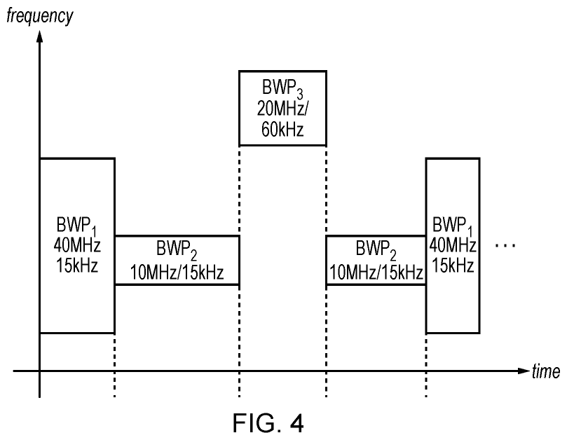

A UE's power consumption depends on the bandwidth of the BWP and other configuration parameters of the bandwidth part, for example the cross-slot scheduling parameters applied to the BWP. That is, the narrower the bandwidth, the lower power consumption. To reduce the power consumption at the UE, Bandwidth Adaptation (BA) is employed to receive or transmit data as required by the UE. When the UE has a large amount of data to receive and or to transmit, a wide pipe of bandwidth is activated while in case there is only a small amount of data for transmission/reception (i.e. low activity or idle), a narrower BWP is activated. It has been proposed that before activation, a UE may be configured in advance using RRC signalling with a number of BWPs (up to four) within a carrier bandwidth. An example is shown in FIG. 4 which provides a plot of frequency against time corresponding to an example related to NR 3GPP specification TS38.300 v15.6.0. As shown in FIG. 4 three different BWPs are configured for a UE comprising a BWP₁ with a width of 40 MHz and subcarrier spacing of 15 kHz, a BWP₂ with a width of 10 MHz and subcarrier spacing of 15 kHz, and a BWP₃ with a width of 20 MHz and subcarrier spacing of 60 kHz. For the example provided by FIG. 4, a UE can reduce power consumption when BWP2 is activated, because this has the lower bandwidth.

Example embodiments can provide a method of operating a UE for D2D communications in which a first receiving UE receives via a control channel or PSCCH of a D2D wireless access interface an indication of communications parameters, such as a bandwidth allocation from a second UE for the first UE to transmit signals representing data to the first UE via a shared channel or PSSCH of the D2D wireless access interface, the D2D wireless access interface providing physical resources for the PSCCH and the physical resources of the PSSCH. The method further comprises receiving the signals representing the data via the physical resources of the PSSCH of the D2D wireless access interface based on the received communications parameters. The physical resources of the PSCCH and/or the PSSCH of the D2D wireless access interface are formed from a default bandwidth part which is pre-established (known) between the UE and the other UE and a non-default bandwidth part which is dynamically configured between the first UE and the second UE. Furthermore the default bandwidth part having a narrower bandwidth of the D2D wireless access interface than the non-default bandwidth part, so that when using the default bandwidth part the UEs can save power.

Bandwidth part (BWP) adaptation is one technique which can be used by a UE to save power. For sidelink power saving, BWP adaptation can be used to save power, as has been specified for NR downlink and uplink communications. However current proposals for the sidelink for NR only provide for one BWP to be configured and configuration of multiple BWPs is not allowed. Furthermore physical resources need to be aligned between a receiver and a transmitter. In other words, the transmitter has to know which BWP is activated for the receiver.

According to example embodiments a UE supporting multiple BWP configurations can be scheduled on the default BWP unless the transmitting UE knows that the receiving UE is monitoring resources other than the default BWP. To be able to receive PSCCH from other transmitting UEs, the receiving UE in some examples always monitors at least the default BWP and in other examples the receiving UE monitors the default BWP as much as possible.

A default BWP can be configured by a wireless access network through radio resource control, RRC, signalling or can be pre-specified as a bandwidth part which exists between a group of UEs before there is a requirement for data to be transmitted between devices. Other attributes include:
A UE switches to a default BWP when there has been no activity on a non-default BWP for a period of time:
   the default BWP is the location that the UE is expected to be monitoring if it is not known where else it might be monitoring;
   DCI/SCI signalling can also be used to signal UE to move to the default BWP
Data can be transmitted on the default BWP itself, although the default BWP may have a limited bandwidth and so the network might only do this if there is not much data to transmit;
The default BWP typically has a smaller bandwidth than a non-default BWP, which can help from a power saving perspective.

A non-default BWP may also be configured by the wireless communications network and can be provided generally for a UE to transmit when a higher bandwidth is required. Other attributes include:
The non-default BWP can be configured by RRC signalling;
A UE does not stay on the non-default BWP when there is no data to transmit, which can be detected using an inactivity timer, which when expired after non-activity would cause the UE to leave the non-default BWP;
The UE can be alternatively signalled by DCI/SCI signalling to move from a non-default BWP to a default BWP or to a different non-default BWP;
The non-default BWP typically has a wider bandwidth than the non-default BWP;

As will be appreciated from the above explanation both a default and a non-default BWPs are pre-configured by RRC signalling. DCI/SCI signalling may then then used to tell a UE which BWP to use, using the known attributes that were pre-configured by RRC.

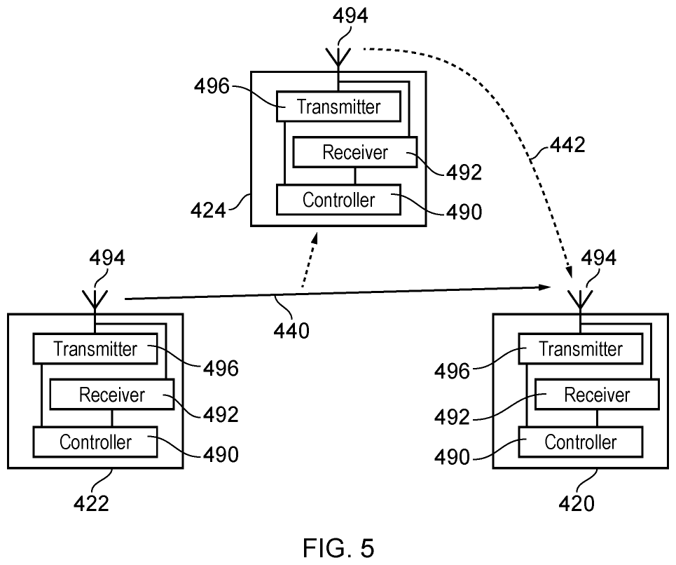

A more detailed illustration of UEs operating in accordance with example embodiments is illustrated in FIG. 5. As shown in FIG. 5, three UEs 420, 422, 424 are shown to form a group of UEs performing D2D communications via sidelinks 440, 442. The D2D communications may be in-coverage, partial coverage or out of coverage. However the sidelinks are formed from a D2D wireless access interface which includes a control channel or PSCCH and a shared channel or PSSCH.

As shown in FIG. 5, a more detailed illustration of a UEs 420, 422, 424 is provided, each of which includes controller circuitry 490, receiver circuitry 492 connected to an antenna 494 and transmitter circuitry 496 also connected to the antenna 494.

The controller circuitry 490 of the UEs 420, 422, 424 is configured to control the transmitter circuitry 496 and the receiver circuitry 492 and may comprise processor circuitry which may in turn comprise various sub-units/sub-circuits for providing functionality as explained further herein. These sub-units may be implemented as discrete hardware elements or as appropriately configured functions of the processor circuitry. Thus the controller 490 may comprise circuitry which is suitably configured/programmed to provide the desired functionality using conventional programming/configuration techniques for equipment in wireless telecommunications systems. Likewise, the transmitter 496 and the receiver 492 may comprise signal processing and radio frequency filters, amplifiers and circuitry in accordance with conventional arrangements. The transmitter 496, receiver 492 and controller 490 are schematically shown in FIG. 5 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the UEs 420, 422, 424 will in general comprise various other elements associated with its operating functionality, for example a power source, user interface, and so forth, but these are not shown in FIG. 5 in the interests of simplicity.

The controllers 490 may be configured to carry out instructions which are stored on a computer readable medium, such as a non-volatile memory. The processing steps described herein may be carried out by, for example, a microprocessor in conjunction with a random access memory, operating according to instructions stored on a computer readable medium.

BWP switching can be UE-specifically performed. For downlink/uplink communications, since a wireless network through the gNB for NR controls access to radio communications resources for the UE, the gNB knows which BWP is activated for the UE. However, for sidelink, a transmitting UE (Tx UE) can control part of the resource allocation for a receiving UE (Rx UE). In addition, multiple Tx UEs can be assumed from a Rx UE perspective. Therefore if a Tx UE indicates BWP switching to an Rx UE, another Tx UE will not know which BWP is activated for the Rx UE.

As shown in FIG. 5 a first UE 422 is transmitting signals which are received by a second UE 420 as represented by an arrow 440 via a sidelink formed by the D2D wireless access interface. The first UE 422 transmits via the PSCCH and the PSSCH of the D2D wireless access interface via one or both of a default BWP and a non-default BWP. As shown in FIG. 5 a third UE 424 may monitor or listen into the transmission by the first UE 422 in order to transmit data itself or to transmit control information via the sidelink 442.

### Embodiment 1

According to one example embodiment, the D2D wireless access interface is configured with a default bandwidth part, BWP, which is within and always inside a non-default BWP in the frequency domain That is to say that, a resource configuration of the D2D wireless access interface is restricted so that the non-default BWP is overlapped with the whole default BWP. In other words, a UE does not expect to be configured with a non-default BWP that is not overlapping with the default BWP. Typically, only one BWP is active, which may be either a default BWP or a non-default BWP. In some examples, multiple non-default BWPs can be configured, but only one BWP is active. Even when the non-default BWP is active, a UE needs to monitor a control channel of the PSCCH within the default BWP.

Example embodiments are arranged to provide a D2D control channel via which UEs may transmit control signals to other UEs using the D2D wireless access interface. According to some example embodiments of the D2D control channel (PSCCH), physical resources for PSCCH monitoring which are common among default BWP and non-default BWP may be configured. For example, CORESETs are common among default and non-default BWP by virtue of there being common Radio Resource Control, RRC, signalling that configures the default and non-default BWPs. Here the CORESET (control resource set) constitutes physical resources for PSCCH monitoring.

In other example embodiments, physical resources for PSCCH monitoring are separately configured for each BWP, but physical resources for PSCCH monitoring on the non-default BWP is restricted within default BWP. For example, although RRC signalling details for each BWP are separate, both BWPs are configured such that the physical resources monitored for PSCCH for either BWP lie in the default BWP.

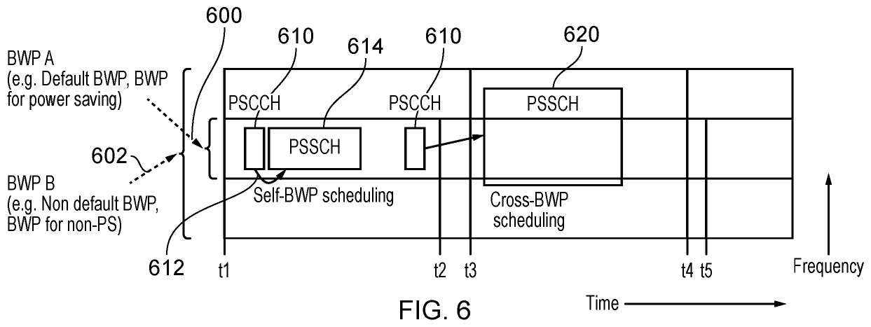

One example embodiment is illustrated in FIG. 6, which shows an example of BWP switching. The BWP switching may be performed according to a bandwidth which is required for transmitting data by the UE. As shown in FIG. 6, which shows a plot of frequency against time, a default BWP 600 also labelled BWP A is shown to have a narrower bandwidth and is within a non-default BWP 602 also referred to as a BWP B. Control signals representing communications parameters are received by a UE from another UE from a control channel or PSCCH 610, which as represented by an arrow 612, allocates resources in one time unit t1 to t2 of a shared channel of PSSCH 614. However in a later time unit t3 to t4, control signals received in a PSCCH 610 allocate physical resources of the PSSCH 620 which includes resource from both the default BWP 600 and the non-default BWP 602. By switching the BWP in accordance with a required transmission bandwidth for example, a power saving can be achieved. BWP A 600 is the default BWP which is used in a power saving mode for a UE. BWP B 602 is a non-default BWP which is used in a non-power saving mode (e.g. high performance mode) for a UE. BWP A is narrower than BWP B.

From time t1, a UE monitors PSCCH 610 on BWP A. A narrowband PSSCH can be transmitted on BWP A using self-BWP scheduling. When a wideband PSSCH is transmitted to the UE, the UE changes the received BWP to BWP B under the control of the PSCCH 610. SCI (sidelink control information) in PSCCH includes a BWP indicator which indicates the BWP scheduling the PSSCH. After the UE receives PSSCH on BWP B, the UE goes back to monitoring BWP A. For example, the return to monitoring BWP A can be controlled by expiry of an inactivity timer, where the inactivity timer can be configured.

The UE can reduce power consumption by using narrower BWP 600 reception from t1 to t2 and from t5 to the next time that BWP switching occurs.

Here, the time from t2 to t3 and from t4 to t5 is the time gap required for BWP switching.

### Embodiment 2

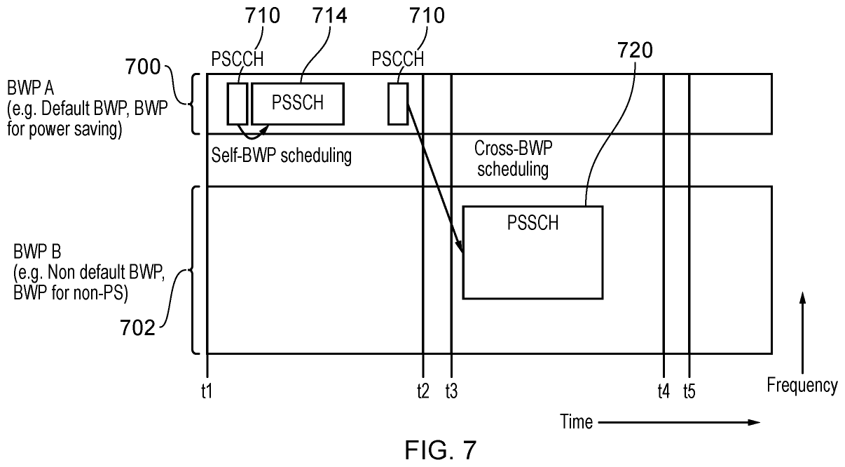

For an example in which the default BWP is outside the non-default BWP in the frequency domain, including the case where it is partially overlapping, and only one BWP is active (i.e. BWP switching is performed) then the PSCCH may be transmitted on only the default BWP. This example is illustrated in FIG. 7. As shown in FIG. 7, which shows a corresponding example to that shown in FIG. 6, the default BWP 700 is outside the non-default BWP 702. Here a PSCCH 710 on the default BWP 700 can schedule a PSSCH on different non-default BWPs 720, which is known as cross-BWP scheduling. Self-BWP scheduling of the PSSCH 714 on the default BWP can be also used.

There are different example techniques for scheduling the different BWP. For example these can be explicitly indicated using a BWP indicator. This can be provided for example in a Sidelink Control Information (SCI) message which can explicitly indicate the scheduled BWP. In another example an implicit indication can be used, for example each non-default BWP can be associated with cast-type (unicast, groupcast, multicast) for D2D communications, priority for D2D data etc. If such an association is configured, the scheduled BWP can be determined by cast-type or priority etc indicated by the SCI message.

If a transmitting UE knows the active non-default BWP for a receiving UE, for example if the transmitting UE is the scheduling UE for a receiving UE using cross-BWP scheduling, then the transmitting UE can transmit further PSCCH/PSSCH for the Rx UE on the scheduled non-default BWP.

In some examples another UE such as the third UE 424 of FIG. 5 can detect the scheduling PSCCH 710, and so can also transmit further PSCCH for the Rx UE on the scheduled non-default BWP. When the transmitting UE signals using PSCCH to a receiving UE, it includes information on the known characteristics of the receiving UE's BWP monitoring status. For example the transmitting UE can include within the PSCCH (or PSSCH) one or more of the following pieces of information regarding the status of the receiving UE:
Size of non-default BWP that the receiving UE is monitoring
The number of subsequent subframes, slots or symbols that the receiving UE will monitor the non-default BWP
DRX (discontinuous reception) parameters related to the receiving UE

If the Rx UE feedbacks a PSFCH (Physical Sidelink Feedback Channel) corresponding to the scheduling PSCCH/PSSCH and other Tx UEs detect the PSFCH, the other Tx UEs can also transmit further PSCCH/PSSCH for the Rx UE on the scheduled non-default BWP. When the receiving UE reports feedback signalling to a transmitting UE using PSFCH, it includes information on the actual characteristics of the receiving UE's BWP monitoring status. For example, the receiving UE can include within the PSFCH one or more of the following pieces of information regarding the status of the receiving UE:
Size of non-default BWP that the receiving UE is monitoring
The number of subsequent subframes, slots or symbols that the receiving UE will monitor the non-default BWP
DRX (discontinuous reception) parameters related to the receiving UE

After PSSCH reception is completed on the non-default BWP, the UE can switch to the default BWP. The switching can be done either right after the reception, or a given time after the reception, where the given time is fixed or predetermined, configured by RRC signalling, or indicated by the SCI scheduling the PSSCH. The feedback signal can be transmitted via a PSFCH transmission which can include a HARQ feedback for the PSSCH. In one example the PSFCH can be transmitted on the default BWP. In another example the PSFCH can be transmitted on the scheduled non-default BWP.

### Embodiment 3

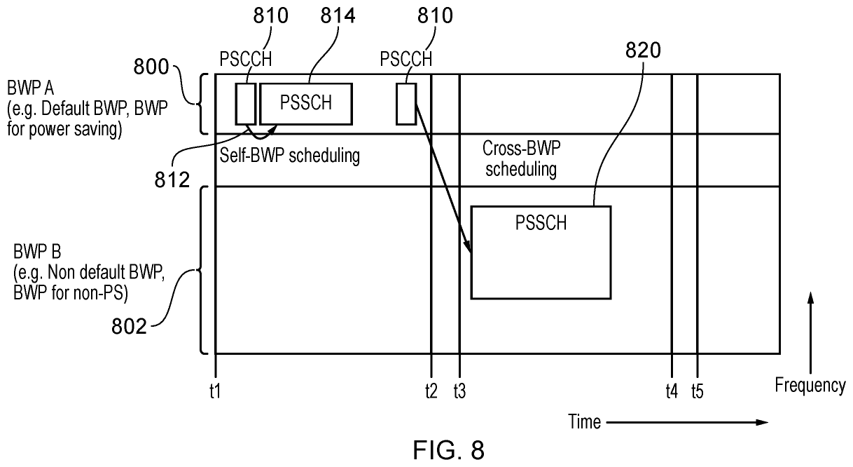

According to another example embodiment shown in FIG. 8 a default BWP 800 can be inside or outside a non-default BWP 802 in the frequency domain (including the case where the default and non-default BWPs are partial overlapping), and Multiple BWPs can be active simultaneously. For this example all procedures in embodiment 1 and 2 are applicable. In other words, only a UE supporting multiple active BWPs is available for BWP adaptation for sidelink. It may be restricted that only one non-default BWP in addition to the default BWP can be active. Operation with multiple active BWPs is illustrated in FIG. 8. FIG. 8 shows a UE having a second active BWP being activated at t3 by a PSCCH 810 that occurs just prior to time t2.

### Embodiment 4

Other example embodiments can be provided based on the three embodiments described above with further adaptations. For example transmit and/or receive parameters can be changed based on BWP switching for power saving. For example:
One or more Tx/Rx parameters can be independently configured for each BWP. Based on the BWP switching as mentioned above, the configured Tx/Rx parameters are changed.
The Tx/Rx parameters are related to power consumption or affect power consumption. As a result, the power consumption can be adaptive.
Preferably, the default BWP is configured with Tx/Rx parameters for relatively low power consumption (and also low performance), and a non-default BWP is configured with Tx/Rx parameters for relatively high power consumption (and also high performance)
As one embodiment, the Tx/Rx parameter is the maximum number of MIMO layers for PSCCH and/or PSSCH.
   The higher the maximum number of MIMO layers is, the higher the power consumption is and the higher the achievable throughput is. The lower the maximum number of MIMO layers is, the lower the power consumption is and the lower the achievable throughput is.
   For an example, the maximum numbers of MIMO layers for the default BWP and non-default BWP are configured as two and eight respectively.

Though embodiments of the present technique have been described largely by way of the example communications system shown in FIGS. 1 to 8, it would be clear to those skilled in the art that they could be equally applied to other systems to those described herein.

### Summary of Operation

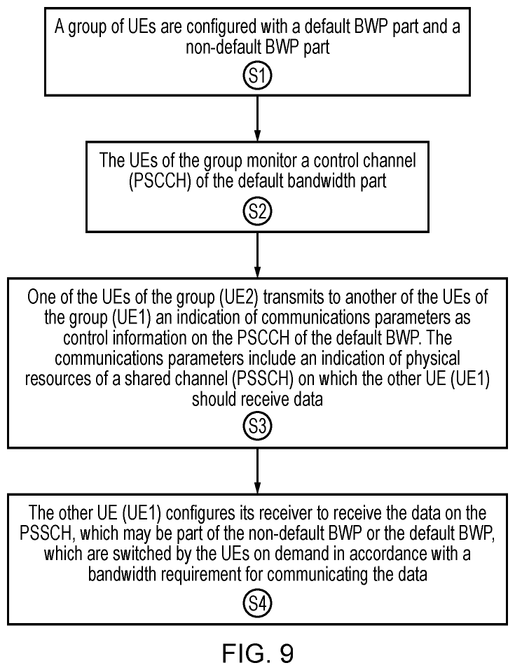

According to the above examples a UEs forming a group of D2D UEs may be configured to communicate via one or both of a default BWP or a non-default BWP. FIG. 9 provides a summary flow diagram illustrating a process performed by UEs according to example embodiments. FIG. 9 is summarized as follows:

S1: A group of UEs exchange signaling information with a wireless communications network, such as RRC signaling which configures each of the UEs of the group to communicate using a D2D wireless access interface. The UEs of the group are configured with a default BWP and a non-default BWP which may have a greater bandwidth of the D2D wireless access interface than the default BWP.

S2: The UEs of the group then monitor a control channel of the default BWP at least for control information which may provide an indication of resources of the shared channel (PSSCH) from which one of the UEs of the group may transmit data. Whilst the control information will always be transmitted on the PSCCH of the default BWP, in some example the physical resources of the PSSCH (shared channel) for transmitting the data may be on the default BWP or non-default BWP or both. The control information may also be transmitted on the PSCCH (control channel) of the non-default BWP.

S3: One of the UEs of the group (UE2) then transmits to another of the UEs of the group (UE1) an indication of communications parameters provided included as least a part of control information on the PSCCH of the default BWP. The communications parameters include an indication of physical resources of a shared channel (PSSCH) on which the other UE, UE1, should receive data.

S4: The other UE (UE1) configures its receiver to receive the data on the PSSCH, which may be part of the non-default BWP or the default BWP, which are switched by the UEs on demand in accordance with a bandwidth requirement for communicating the data.

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may form part of communications systems other than those defined by the present disclosure.

The following numbered paragraphs provide further example aspects and features of the present technique:

Paragraph 1. A method of operating a communications device configured for device-to-device, D2D, communications, the method comprising
receiving on a control channel of a D2D wireless access interface an indication of communications parameters from another communications device for that other communications device to transmit signals representing data to the communications device via a shared channel of the D2D wireless access interface, the D2D wireless access interface providing physical resources for the control channel and the physical resources of the shared channel, and
receiving the signals representing the data via the physical resources of the shared channel of the D2D wireless access interface based on the received communications parameters, wherein the physical resources of the shared channel of the D2D wireless access interface are formed from a default bandwidth part and a non-default bandwidth part which are configured for the communications device and the other communications device, the default bandwidth part having a narrower bandwidth of the D2D wireless access interface than the non-default bandwidth part.

Paragraph 2. The method of paragraph 1, wherein the default bandwidth part is configured to be within a frequency range of the non-default bandwidth part, and the receiving the signals representing the data comprises receiving the signals from one of the default bandwidth part or the non-default bandwidth part, only one of which is active at a given time.

Paragraph 3. The method of paragraph 2, wherein the receiving the indication of communications parameters physical resources of the control channel of the D2D wireless access interface comprises
monitoring physical resources of the D2D wireless access interface which form the control channel for both the default bandwidth part and the non-bandwidth part to receive the indication of the communications parameters.

Paragraph 4. The method of paragraph 3, wherein physical resources of the control channel of the D2D wireless access interface are common among the default bandwidth part and the non-default bandwidth part.

Paragraph 5. The method of paragraph 2, wherein the control channel is provided on the default bandwidth part and the non-default bandwidth part, the method comprising
monitoring physical resources of the control channel on the default bandwidth part and the non-default bandwidth part, wherein the physical resources of the control channel of the D2D wireless access interface are configured separately for the default bandwidth part and the non-default bandwidth part, the physical resources of the control channel of the default bandwidth part being within the default bandwidth part.

Paragraph 6. The method of paragraph 1, wherein the default bandwidth part is configured to be at least partially outside a frequency range of the non-default bandwidth part.

Paragraph 7. The method of paragraph 6, wherein the receiving the signals representing the data comprises
receiving the signals from one of the default bandwidth part or the non-default bandwidth part, only one of the default bandwidth part or the non-default bandwidth parts being active at any given time.

Paragraph 8. The method of paragraph 7, wherein physical resources of the control channel of the D2D wireless access interface are formed within the default bandwidth part and not the non-default bandwidth part, and the receiving on the control channel of a D2D wireless access interface the indication of communications parameters from the other communications device comprises
monitoring, by the communications device, the control channel provided on the physical resources of the default bandwidth part of the D2D wireless access interface.

Paragraph 9. The method of paragraph 7, wherein physical resources of the control channel of the D2D wireless access interface are provided on both the default bandwidth part and the non-default bandwidth part, and the receiving on the control channel of a D2D wireless access interface the indication of communications parameters from the other communications device comprises
monitoring, by the communications device, the control channel provided on the physical resources of both the default bandwidth part of the D2D wireless access interface and the non-default bandwidth part of the D2D wireless access interface, and
receiving the indication of the communications parameters on the physical resources of the control channel of the non-default bandwidth part which allocates physical resources of the shared channel on the non-default bandwidth part, the signals representing the data being received on the shared channel of the non-default bandwidth part.

Paragraph 10. A method of operating a communications device configured for device-to-device, D2D, communications, the method comprising
monitoring a control channel of a D2D wireless access interface on which a first communications device can transmit a first indication of communications parameters to a second communications device for the second communications device to receive first signals representing first data via a shared channel of the D2D wireless access interface, the D2D wireless access interface providing physical resources for the control channel and the physical resources of the shared channel on one or both of a default bandwidth part and a non-default bandwidth part which are configured for the first communications device and the second communications device,
detecting the communications parameters transmitted on the control channel providing the indication of the physical resources of the shared channel for the first communications device to transmit the first signals representing the first data to the second communications device,
transmitting, by the communications device, a second indication of second communications parameters to the second communications device for the second communications device to receive second signals representing second data via the shared channel of the D2D wireless access interface, and
transmitting the second signals representing the second data via the physical resources of the shared channel of the D2D wireless access interface based on the second communications parameters.

Paragraph 11. The method of paragraph 10, wherein the first indication of the communications parameters is detected on the control channel of the non-default bandwidth part and the transmitting the second indication of the second communications parameters includes transmitting the second indication on the physical resources of the non-default bandwidth part.

Paragraph 12. The method of paragraph 10 or 11, wherein the first indication of communications parameters includes information of characteristics of a whether the second communications device is monitoring the control channel of the default bandwidth part or the non-default bandwidth part.

Paragraph 13. The method of paragraph 10, 11 or 12, wherein the transmitting the second indication of communications parameters to the second communications device comprises
detecting a feedback signal transmitted by the second communications device to the first communications device in response to the first indication of communications parameters, and
transmitting the second indication of communications parameters in response to detecting the feedback signals.

Paragraph 14. The method of paragraph 13, wherein the feedback signal includes an indication of when the second communications device will be monitoring the control channel of the default bandwidth part or the non-default bandwidth part.

Paragraph 15. The method of paragraph 13 or 14, wherein the feedback signal includes an indication of physical resources of the control channel of the default bandwidth part or the non-default bandwidth part which will be monitored by the second communications device.

Paragraph 16. The method of paragraph 1, wherein the receiving the signals representing the data comprises
receiving the signals from both of the default bandwidth part and the non-default bandwidth part, both of the default bandwidth part and the non-default bandwidth parts being active at the same time.

Paragraph 17. The method of paragraph 1, wherein the communications parameters comprise first communications parameters for configuring the communications device to receive signals from the default bandwidth part and second communications parameters for configuring the communications device to receive signals from the non-default bandwidth part.

Paragraph 18. The method of paragraph 17, wherein the first communications parameters are different to the second communications parameters.

Paragraph 19. The method of paragraph 17 or 18, wherein the first communications parameters include a maximum number of Multiple Input Multiple Output, MIMO, layers for receiving signals via the physical resources of the control channel or the shared channel of the default bandwidth part, and the second communications parameters include a maximum number of Multiple Input Multiple Output, MIMO, layers for receiving signals via the physical resources of the control channel or the shared channel of the non-default bandwidth part.

Paragraph 20. The method of any of paragraphs 1 to 18, wherein the default bandwidth part and the non-default bandwidth part are configured by a wireless communications network, the default bandwidth part having a narrower bandwidth than the non-default bandwidth part.

Paragraph 21. A communications device configured for device-to-device, D2D, communications, the communications device comprising
receiver circuitry configured to receive signals transmitted via a D2D wireless access interface, and
controller circuitry configured to control the receiver circuitry
to receive on a control channel of the D2D wireless access interface an indication of communications parameters from another communications device for that other communications device to transmit signals representing data to the communications device via a shared channel of the D2D wireless access interface, the D2D wireless access interface providing physical resources for the control channel and the physical resources of the shared channel, and
to receive the signals representing the data via the physical resources of the shared channel of the D2D wireless access interface based on the received communications parameters, wherein the physical resources of the shared channel of the D2D wireless access interface are formed from a default bandwidth part and a non-default bandwidth part which are configured for the communications device and the other communications device, the default bandwidth part having a narrower bandwidth of the D2D wireless access interface than the non-default bandwidth part.

Paragraph 22. The communications device of paragraph 21, wherein the receiver circuitry is configured to receive signals transmitted by an infrastructure equipment of a wireless communications network, the signals being transmitted via a wireless access interface provided by the wireless communications network, and the controller circuitry is configured to control the receiver circuitry
to receive control signals for configuring the receiver circuitry with the default bandwidth part and the non-default bandwidth part, and
to configure the receiver circuitry to receive the signals from the default bandwidth part and the non-default bandwidth part.

Paragraph 23. A communications device configured for device-to-device, D2D, communications, the communications device comprising
transmitter circuitry configured to transmit signals via a D2D wireless access interface,
receiver circuitry configured to receive signals transmitted via the D2D wireless access interface, and
controller circuitry configured to control the receiver circuitry
to monitor a control channel of the D2D wireless access interface on which a first communications device can transmit a first indication of communications parameters to a second communications device for the second communications device to receive first signals representing first data via a shared channel of the D2D wireless access interface, the D2D wireless access interface providing physical resources for the control channel and the physical resources of the shared channel on one or both of a default bandwidth part and a non-default bandwidth part which are configured for the first communications device and the second communications device,
to detect the communications parameters transmitted on the control channel providing the indication of the physical resources of the shared channel for the first communications device to transmit the first signals representing the first data to the second communications device, and controller circuitry is configured to control the transmitter circuitry
to transmit a second indication of second communications parameters to the second communications device for the second communications device to receive second signals representing second data via the shared channel of the D2D wireless access interface, and
to transmit the second signals representing the second data via the physical resources of the shared channel of the D2D wireless access interface based on the second communications parameters.

Paragraph 24. The communications device of paragraph 23, wherein the receiver circuitry is configured to receive signals transmitted by an infrastructure equipment of a wireless communications network, the signals being transmitted via a wireless access interface provided by the wireless communications network, and the controller circuitry is configured to control the receiver circuitry
to receive control signals for configuring the receiver circuitry with the default bandwidth part and the non-default bandwidth part, and
to configure the receiver circuitry to receive the signals from the default bandwidth part and the non-default bandwidth part.

Paragraph 25. A computer program providing computer executable code, which when executed by a processor causes the processor to perform the method of any of paragraphs 1 to 20.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] RP-182090, “Revised SID: Study on NR Industrial Internet of Things (IoT),” 3GPP RAN #81.
[2] Holma H. and Toskala A, “LTE for UMTS OFDMA and SC-FDMA based radio access”, John Wiley and Sons, 2009.

1. A method of operating a communications device configured for device-to-device, D2D, communications, the method comprising
receiving on a control channel of a D2D wireless access interface an indication of communications parameters from another communications device for that other communications device to transmit signals representing data to the communications device via a shared channel of the D2D wireless access interface, the D2D wireless access interface providing physical resources for the control channel and the physical resources of the shared channel, and
receiving the signals representing the data via the physical resources of the shared channel of the D2D wireless access interface based on the received communications parameters, wherein the physical resources of the shared channel of the D2D wireless access interface are formed from a default bandwidth part and a non-default bandwidth part which are configured for the communications device and the other communications device, the default bandwidth part having a narrower bandwidth of the D2D wireless access interface than the non-default bandwidth part.

2. The method of claim 1, wherein the default bandwidth part is configured to be within a frequency range of the non-default bandwidth part, and the receiving the signals representing the data comprises receiving the signals from one of the default bandwidth part or the non-default bandwidth part, only one of which is active at a given time.

3. The method of claim 2, wherein the receiving the indication of communications parameters physical resources of the control channel of the D2D wireless access interface comprises
monitoring physical resources of the D2D wireless access interface which form the control channel for both the default bandwidth part and the non-bandwidth part to receive the indication of the communications parameters.

4. The method of claim 3, wherein physical resources of the control channel of the D2D wireless access interface are common among the default bandwidth part and the non-default bandwidth part.

5. The method of claim 2, wherein the control channel is provided on the default bandwidth part and the non-default bandwidth part, the method comprising
monitoring physical resources of the control channel on the default bandwidth part and the non-default bandwidth part, wherein the physical resources of the control channel of the D2D wireless access interface are configured separately for the default bandwidth part and the non-default bandwidth part, the physical resources of the control channel of the default bandwidth part being within the default bandwidth part.

6. The method of claim 1, wherein the default bandwidth part is configured to be at least partially outside a frequency range of the non-default bandwidth part.

7. The method of claim 6, wherein the receiving the signals representing the data comprises
receiving the signals from one of the default bandwidth part or the non-default bandwidth part, only one of the default bandwidth part or the non-default bandwidth parts being active at any given time.

8. The method of claim 7, wherein physical resources of the control channel of the D2D wireless access interface are formed within the default bandwidth part and not the non-default bandwidth part, and the receiving on the control channel of a D2D wireless access interface the indication of communications parameters from the other communications device comprises
monitoring, by the communications device, the control channel provided on the physical resources of the default bandwidth part of the D2D wireless access interface.

9. The method of claim 7, wherein physical resources of the control channel of the D2D wireless access interface are provided on both the default bandwidth part and the non-default bandwidth part, and the receiving on the control channel of a D2D wireless access interface the indication of communications parameters from the other communications device comprises
monitoring, by the communications device, the control channel provided on the physical resources of both the default bandwidth part of the D2D wireless access interface and the non-default bandwidth part of the D2D wireless access interface, and
receiving the indication of the communications parameters on the physical resources of the control channel of the non-default bandwidth part which allocates physical resources of the shared channel on the non-default bandwidth part, the signals representing the data being received on the shared channel of the non-default bandwidth part.

10. A method of operating a communications device configured for device-to-device, D2D, communications, the method comprising
monitoring a control channel of a D2D wireless access interface on which a first communications device can transmit a first indication of communications parameters to a second communications device for the second communications device to receive first signals representing first data via a shared channel of the D2D wireless access interface, the D2D wireless access interface providing physical resources for the control channel and the physical resources of the shared channel on one or both of a default bandwidth part and a non-default bandwidth part which are configured for the first communications device and the second communications device,
detecting the communications parameters transmitted on the control channel providing the indication of the physical resources of the shared channel for the first communications device to transmit the first signals representing the first data to the second communications device,
transmitting, by the communications device, a second indication of second communications parameters to the second communications device for the second communications device to receive second signals representing second data via the shared channel of the D2D wireless access interface, and
transmitting the second signals representing the second data via the physical resources of the shared channel of the D2D wireless access interface based on the second communications parameters.

11. The method of claim 10, wherein the first indication of the communications parameters is detected on the control channel of the non-default bandwidth part and the transmitting the second indication of the second communications parameters includes transmitting the second indication on the physical resources of the non-default bandwidth part.

12. The method of claim 10, wherein the first indication of communications parameters includes information of characteristics of a whether the second communications device is monitoring the control channel of the default bandwidth part or the non-default bandwidth part.

13. The method of claim 10, wherein the transmitting the second indication of communications parameters to the second communications device comprises
detecting a feedback signal transmitted by the second communications device to the first communications device in response to the first indication of communications parameters, and
transmitting the second indication of communications parameters in response to detecting the feedback signals.

14. The method of claim 13, wherein the feedback signal includes an indication of when the second communications device will be monitoring the control channel of the default bandwidth part or the non-default bandwidth part.

15. The method of claim 13, wherein the feedback signal includes an indication of physical resources of the control channel of the default bandwidth part or the non-default bandwidth part which will be monitored by the second communications device.

16. The method of claim 1, wherein the receiving the signals representing the data comprises
receiving the signals from both of the default bandwidth part and the non-default bandwidth part, both of the default bandwidth part and the non-default bandwidth parts being active at the same time.

17. The method of claim 1, wherein the communications parameters comprise first communications parameters for configuring the communications device to receive signals from the default bandwidth part and second communications parameters for configuring the communications device to receive signals from the non-default bandwidth part.

18. The method of claim 17, wherein the first communications parameters are different to the second communications parameters.

19. The method of claim 17, wherein the first communications parameters include a maximum number of Multiple Input Multiple Output, MIMO, layers for receiving signals via the physical resources of the control channel or the shared channel of the default bandwidth part, and the second communications parameters include a maximum number of Multiple Input Multiple Output, MIMO, layers for receiving signals via the physical resources of the control channel or the shared channel of the non-default bandwidth part.

20. The method of claim 1, wherein the default bandwidth part and the non-default bandwidth part are configured by a wireless communications network, the default bandwidth part having a narrower bandwidth than the non-default bandwidth part.

21.-25. (canceled)
